(19) United States
(12) Patent Application Publication
(10) Pub. No.: US 2025/0060887 A1
(43) Pub. Date: Feb. 20, 2025

(54) METHODS AND APPARATUS TO FACILITATE ACCESS CONTROL IN MEMORY

(71) Applicant: Texas Instruments Incorporated, Dallas, TX (US)

(72) Inventors: Prasanth Viswanathan Pillai, Bangalore (IN); David Foley, Sugar Land, TX (US); Rajasekhar Allu, Plano, TX (US); Amrit Mundra, Allen, TX (US); Patrick Kruse, Richmond, TX (US)

(21) Appl. No.: 18/629,657

(22) Filed: Apr. 8, 2024

Related U.S. Application Data
(60) Provisional application No. 63/532,702, filed on Aug. 15, 2023.

(51) Int. Cl. G06F 3/06

(52) U.S. Cl. CPC G06F 3/0622; G06F 3/0655; G06F 3/0679

(57) ABSTRACT

Methods, apparatus, systems, and articles of manufacture are described to facilitate access control in memory. An example method includes accessing state values stored in non-volatile memory, the state values corresponding to a state of the non-volatile memory; responsive to obtaining a request to enter a diagnostic mode, authenticating credentials corresponding to the request; determining the state of the non-volatile memory based on the state values; and determining whether to permit or prohibit access to the non-volatile memory based on the determined state.

### RELATED APPLICATIONS

This application claims priority to U.S. Provisional Patent Application No. 63/532,702, filed Aug. 15, 2023, which is incorporated herein by reference in its entirety.

### TECHNICAL FIELD

This description relates generally to circuits, and, more particularly, to methods and apparatus to facilitate access control in memory.

### BACKGROUND

Devices including electronics are produced by a manufacturer. Such devices may include processing circuitry, memory, etc. After the device is deployed, a customer can install sensitive data, including proprietary code, cryptographic data, keys, and other data into the memory of the device that a customer does not want others to access. If a device fails, the customer can send the device to the manufacturer or another entity to debug the device to determine the reason for the failure.

### SUMMARY

An example of the description includes an apparatus comprising a non-volatile memory configured to store a set of state values, processor circuitry coupled to the non-volatile memory and configured to store data to the non-volatile memory, and security manager circuitry coupled to the non-volatile memory and configured to access the set of state values, responsive to obtaining a request to enter a diagnostic mode, authenticate credentials corresponding to the request, determine the state of the non-volatile memory based on the set of state values, and determine whether to permit or prohibit access to the non-volatile memory based on the determined state. Other examples are described.

An example method includes accessing state values stored in non-volatile memory, the state values corresponding to a state of the non-volatile memory; responsive to obtaining a request to enter a diagnostic mode, authenticating credentials corresponding to the request; determining the state of the non-volatile memory based on the state values; and determining whether to permit or prohibit access to the non-volatile memory based on the determined state. Other examples are described.

An device includes: a non-volatile memory that includes a memory bank configured to store a set of state values corresponding to a state of the non-volatile memory; and a memory controller coupled to the non-volatile memory and configured to write the set of state values to the memory bank based on the state of the non-volatile memory. Other examples are described.

### BRIEF DESCRIPTION OF THE DRAWINGS

FIG. 1 is an example state diagram illustrating different states of memory in a computing device.

FIG. 2 is a block diagram of an example of a device that implements the memory.

FIG. 3 illustrates a flowchart representative of example machine readable instructions or operations that may be executed, instantiated, or performed by example programmable circuitry to implement the device circuitry of FIG. 2 to facilitate access control in memory.

FIG. 4 illustrates memory in the memory of FIG. 2 that corresponds to a state of the memory.

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

A computing device is any device that includes processing circuitry to perform one or more operations. Most computing devices include non-volatile memory that retains stored values even after power is removed from the computing device. Non-volatile memory includes flash memory, ferroelectric random-access memory (FeRAM), magnetic random-access memory (MRAM), phase-change memory (PCM), resistive random-access memory (RRAM), etc. During device manufacturing, a manufacturer can initialize, prepare, and test a computing device for use by a customer. After the customer receives a computing device, the customer can initialize the non-volatile memory by storing sensitive data such as keys (e.g., cryptographic keys, authentication keys, etc.), proprietary code, or other information into the non-volatile memory.

If a device failure occurs, the customer can send the computing device back to the manufacturer or to another entity for failure analysis (e.g., debugging). However, the customer may want to limit the ability of the manufacturer or another untrusted party to access information stored into the device. The device failure may occur in the non-volatile memory or may occur in another component of the computing device. Before sending the computing device back to the manufacturer for debugging, the customer determines whether the error occurred in the non-volatile memory or in a different component of the computing device. If the error occurred in the non-volatile memory, the customer deletes the data outside of the location where the error occurred to avoid providing the sensitive data to the entity that will debug the computing device. The customer may retain some of the information stored at or near the location of the non-volatile memory where the failure occurred for debugging purposes. However, the customer will typically delete any data that is not needed for debugging to avoid providing sensitive data to the manufacturer.

Traditionally, if the failure occurs outside of the non-volatile memory, the customer deletes all of the data in the non-volatile memory because the deleted data is not needed for debugging. In this manner, all the sensitive data can be removed and, therefore, cannot be accessed by a third party (e.g., the manufacturer or any other entity). However, verifying that the non-volatile memory has been properly erased may be difficult because external boot options may already be disabled due to the failure. Examples described herein eliminate the actions traditionally required by a customer before returning a computing device for failure analysis when the failure does not occur in the non-volatile memory.

To provide a seamless failure analysis process for the customer, examples described herein utilize security manager circuitry to disable access to the non-volatile memory when a failure occurs outside of the non-volatile memory. In this manner, the data stored in the non-volatile memory is inaccessible to a manufacturer or other entity and is protected without requiring the user to delete the data prior to sending the computing device to be debugged. The state of the non-volatile memory identifies whether keys have been provisioned in the non-volatile memory, whether codes have been stored in the non-volatile memory, and whether a fault has occurred in the non-volatile memory. The user and/or a computing device tracks the state and stores, into the non-volatile memory, one or more state values corresponding to the current state of the non-volatile memory.

When the state changes, the one or more state values corresponding to the current state of the non-volatile memory are provided to the security manager circuitry. In this manner, when the security manager circuitry obtains a request to cause the computing device to operate in a diagnostic mode for debugging purposes, the security manager circuitry can enable or disable access to the non-volatile memory based on the one or more state values. For example, if the one or more state values correspond to a state associated with a failure in the non-volatile memory, the security manager circuitry enables access to the non-volatile memory so that the failure can be debugged. However, if the one or more state values corresponds to a state not associated with a failure in the non-volatile memory, the security manager circuitry disables access to the non-volatile memory to protect the data stored in the non-volatile memory. Thus, when a failure outside of the non-volatile memory occurs, the customer does not need to delete the non-volatile memory to protect the information stored in the non-volatile memory when returning a device for debugging because the security manager circuitry prevents anyone from accessing the data in the non-volatile memory. Accordingly, examples described herein provide a seamless and secure return of a computing device that includes non-volatile memory.

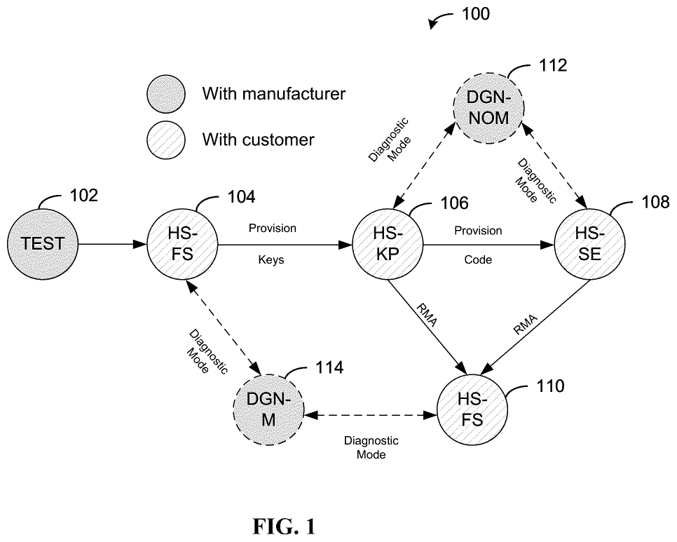

FIG. 1 is example state diagram 100 illustrating the different states of memory within a device. The state diagram 100 includes a test state 102, a high security-field securable state (HS-FS) 104, a high security-key provisioned state (HS-KP) 106, a high security-security enabled state (HS-SE) 108, a high security-failure analysis state (HS-FA) 110, a diagnostic—no memory state (DGN-NOM) 112, and a diagnostic memory state (DGN-M) 114.

In the test state 102 of FIG. 1, the device may be tested by the manufacturer before being sent to a customer. In the test state 102, the manufacturer can perform various tests to ensure that the device is operating correctly and according to any standards or requirements. After testing is complete, the device is provided to the consumer and the non-volatile memory is initialized to the HS-FS state 104. The HS-FS state 104 of the non-volatile memory may be considered an initial state. At the HS-FS state 104, the customer has not yet provisioned/stored keys and has not stored/provisioned code into the non-volatile memory.

After the customer provisions or stores keys into the non-volatile memory, the device enters into the HS-KP state 106 of FIG. 1. Because the keys include sensitive data (e.g., authentication keys, cryptographic keys, etc.), the HS-KP state 106 is the first state in which overriding the device for debugging may result in the non-volatile memory being decoupled or otherwise being made unavailable to anyone.

In some examples, after the customer provisions the keys to the non-volatile memory, the customer can store one or more state values into one or more memory cells of the non-volatile memory to indicate that the keys have been provisioned. In some examples, a processing device can automatically store the one or more state values into the one or more memory cells of the non-volatile memory after the user provisioned keys into the non-volatile memory to indicate that the keys have been provisioned. Accordingly, the one or more state values in the one or more memory cells indicate the state of the non-volatile memory. As further described below, security manager circuitry can access the one or more state values to determine the state of the non-volatile memory after a request to cause the device to operate in a diagnostic mode is obtained. In this manner, the security manager circuitry can enable or disable access to the non-volatile memory based on the state of the non-volatile memory. For example, if a diagnostic mode request is obtained while the one or more state values indicate that the device is in the HS-KP state 106, the security manager circuitry will disable access to the non-volatile memory to cause the device to enter into the diagnostic mode no memory state 112, as further described below.

After the customer provisions or stores code into the non-volatile memory, the device enters into the HS-SE state 108 of FIG. 1. Because the code may include proprietary and/or sensitive information, the HS-SE state 108 (also referred to as a code provisioned state) is the second state in which overriding the device for debugging may result in the non-volatile memory being decoupled or being made unavailable to anyone. In some examples, after the customer provisioned the code to the non-volatile memory, the customer can store one or more state values into one or more memory cells of the non-volatile memory to indicate that the code has been provisioned. In some examples, a processing device can automatically store the one or more state values into the one or more memory cells of the non-volatile memory after the user provisioned the code into the non-volatile memory to indicate that the code has been provisioned. Accordingly, the one or more state values in the one or more memory cells indicate the state of the non-volatile memory. As further described below, security manager circuitry can access the one or more state values to determine the state of the non-volatile memory after a request to cause the device to operate in a diagnostic mode is obtained. In this manner, the security manager circuitry can enable or disable access to the non-volatile memory based on the state of the non-volatile memory. For example, if a diagnostic mode request is obtained while the one or more state values indicate that the device is in the HS-SE state 108, the security manager circuitry may disable access to the non-volatile memory to cause the device to enter into the diagnostic no memory state 112, as further described below.

If a failure occurs at the non-volatile memory (e.g., a non-volatile memory failure) while the device is operating in the HS-KP state 106 or the HS-SE state 108, the device enters into an HS-FA state 110 of FIG. 1 (e.g., a non-volatile memory failure state). To transform into the HS-FA state 110, the user may perform actions (e.g., a return mechanism authorization (RMA) protocol) to delete sensitive information while maintaining the data at a location or near a location associated with the failure. For example, if the failure occurred while accessing or storing information at a particular location of the non-volatile memory, the user may maintain the information at the location. Also, the user may maintain information at a number of locations near the location where the failure occurred and delete the remaining data. In this manner, during debugging, the manufacturer can access the data at or near the location where the failure occurred and run debugging protocols based on the accessed data. In some examples, after the customer performed the RMA protocol, the customer can store one or more state values into one or more memory cells of the non-volatile memory to indicate that the RMA protocol is complete (e.g., corresponding to the HS-FA state 110). In some examples, a processing device can automatically store the one or more state values into the one or more memory cells of the non-volatile memory after the customer performs the RMA protocol to indicate the HS-FA state 110 of the non-volatile memory. Accordingly, the one or more state values in the one or more memory cells indicate the state of the non-volatile memory. As further described below, security manager circuitry can access the one or more state values to determine the state of the non-volatile memory after a request to cause the device to enter a diagnostic mode is obtained. In this manner, the security manager circuitry can enable or disable access to the non-volatile memory based on the state of the non-volatile memory. For example, if a diagnostic mode request is obtained while the one or more state values indicate that the device is in the HS-FA state 110, the security manager circuitry will enable access to the non-volatile memory to cause the device to enter into the diagnostic memory state 114, as further described below.

The DGN-NOM state 112 of FIG. 1 occurs after a manufacturer gains access to the device for debugging and requests a diagnostic mode while the non-volatile memory is in an HS-KP state 106 or a HS-SE state 108. As described above, if a failure does not occur in the non-volatile memory, and sensitive data has already been stored in the non-volatile memory, the security controller will disable access to the non-volatile memory because that information is irrelevant to the debugging of the failure. Accordingly, after the security manager circuitry obtains a request to cause the device to enter a diagnostic mode, the security manager circuitry can determine the state of the non-volatile memory and enter into the DGN-NOM state 112 if the current state of the non-volatile memory is HS-KP state 106 or HS-SE state 108. The DGN-NOM state 112 protects the customers data without requiring additional actions from the customer.

The DGN-M state 114 of FIG. 1 occurs after a manufacturer gains access to the device for debugging purposes and requests a diagnostic mode while the non-volatile memory is in an HS-FS state 104 or an HS-FA state 110. As described above, in the HS-FS state 104, no sensitive data has been stored into the non-volatile memory. Accordingly, there is no need to disable access to the non-volatile memory. Thus, if the manufacturer requests to cause the device to enter a diagnostic mode, the security manager circuitry enables access to the non-volatile memory while the non-volatile memory is in the HS-FS state 104. In the HS-FA state 110, the customer has already performed the RMA protocol to delete sensitive data stored in the non-volatile memory while maintaining enough information to debug the failure. Accordingly, if the manufacturer requests the device to enter diagnostic mode, the security manager circuitry enables access to the non-volatile memory based on the non-volatile memory being in the HS-FA state 110.

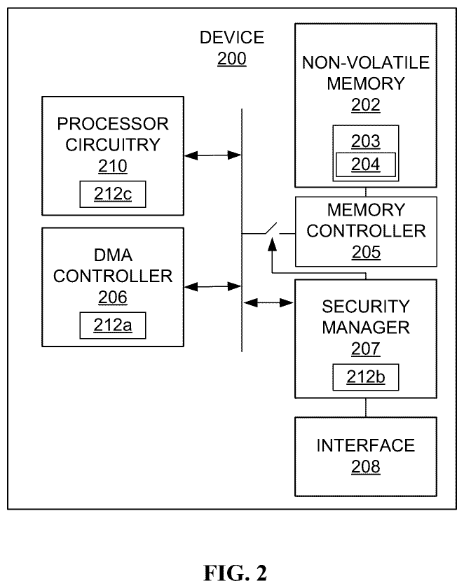

FIG. 2 is a block diagram of an example device 200 described in conjunction with examples described herein. The device 200 includes non-volatile memory 202, a memory bank 203, memory cells 204, a memory controller 205, a direct memory access (DMA) controller 206, a security manager 207, an interface 208, processor circuitry 210, and machine-readable instructions 212a-c.

The device 200 of FIG. 2 may be any device that includes non-volatile memory and processing circuitry. For example, the device 200 may be a computer, a cell phone, a tablet, a server, a cloud or edge-based device, a television, a video gaming device, an automotive computing device, and/or any other device that includes, or is otherwise connected to, non-volatile memory and processing circuitry.

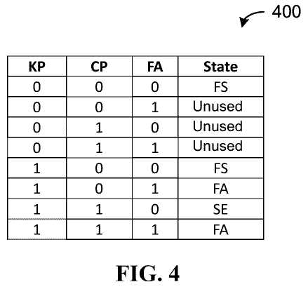

The non-volatile memory 202 of FIG. 2 is memory that can store data and maintains the stored data even after power is removed. The non-volatile memory 202 may be flash memory, ferroelectric random-access memory (FeRAM), magnetic random-access memory (MRAM), phase-change memory (PCM), resistive random-access memory (RRAM), etc. The non-volatile memory 202 includes the example memory bank 203 that includes memory cells for storing data and the memory controller 205. The memory controller 205 reads (e.g., accesses) or writes (e.g., stores) data into the memory bank 203 based on instructions from the DMA controller 206 or processor circuitry 210. After a customer obtains the device 200, the customer can store key information, code, etc. in the memory bank 203 of the non-volatile memory 202. The memory bank 203 of the non-volatile memory 202 includes memory cells 204 reserved to store state information. Accordingly, after the user performs particular actions to cause the non-volatile memory 202 to change states (e.g., provisions keys, provisions code, performs an RMA), the user directly or indirectly changes the value of the one or more memory cells 204 to indicate that the actions have occurred. In some examples, after the user performs the particular action, a non-volatile memory controller (e.g., memory controller 205) or the processor circuitry 210 automatically adjusts the state values in the one or more memory cells 204 to indicate that the actions have occurred. Accordingly, the state values in the one or more memory cells 204 correspond to the state of the non-volatile memory 202. The state values stored in the one or more memory cells 204 are protected. For example, the entire sector that stores the state information may be programmable only on the device 200 (e.g., each bit can be transitioned from 1 to 0 but cannot be transitioned from 0 to 1). In such examples, the sector is not erasable after being out of test mode. Accordingly, after programmed by a user, the state may not be erased. Thus, an attacker would need device specific credentials to override any state values of the one or more memory cells 204. An example of the correlation between the state values of the memory cells 204 and the state of the non-volatile memory 202 is further described below in conjunction with FIG. 4.

The DMA controller 206 of FIG. 2 performs a direct memory access to read, write, or otherwise access state values in the non-volatile memory 202, such as the memory cells 204. As described above, the state values stored in the memory cells 204 correspond to the state of the non-volatile memory 202. The DMA controller 206 stores the accessed state values into storage (e.g., one or more registers, flip flops, other storage devices, etc.) in the security manager 207. In some examples, the DMA controller 206 works with a memory controller 205 of the non-volatile memory 202 to access the data from the memory cells 204. For example, in response to a direct memory access instruction from the DMA controller 206, the memory controller 205 can output the data corresponding to the direct memory access instruction. In some examples, the DMA controller 206 can use any combination of hardcoded logic and/or programmable logic that executes or instantiates the machine-readable instructions 212a (also referred to as computer readable instructions or instructions) to operate.

The security manager 207 of FIG. 2 (also referred to as security manager circuitry) is circuitry that controls access to the non-volatile memory 202 while entering into a diagnostic mode. The security manager 207 includes any combination of one or more register(s), flip flop(s), or other storage device(s) to store the state values accessed from the memory cells 204. After the security manager 207 obtains a request to enter into the diagnostic mode (e.g., via the interface 208), the security manager 207 first authenticates the request by sending information corresponding to the request to the processor circuitry 210 for authentication. For example, the request includes information that can authenticate that the entity requesting the diagnostic mode is authentic. In some examples, the request may include credentials of the manufacturer and credentials associated with the device 200 itself. For example, after a customer returns the device 200 for debugging, the customer may provide device specific or customer specific credentials to the manufacturer (also referred to as device credentials or customer credentials). Also, the manufacturer may have manufacturer specific credentials that is provided with the diagnostic mode request. As further described below, the processor circuitry 210 can authenticate the diagnostic mode request based on the manufacturer specific credentials and the device/customer specific credentials. After the processor circuitry 210 authenticates the manufacturer to cause the device 200 to enter a diagnostic mode, the security manager 207 processes the stored state values to determine the state of the non-volatile memory 202. The security manager 207 controls the access to the non-volatile memory 202 in the diagnostic mode based on the determined state. For example, if the security manager 207 determines that the state of the device 200 is in the HS-FS state 104 or the HS-FA state 110 of FIG. 1, the security manager 207 sets the state of the device 200 to the diagnostic memory state 114 and enables access to the non-volatile memory 202. If the security manager 207 determines that the state of the device 200 is in the HS-KP state 106 or the HS-SE state 108 of FIG. 1, the security manager 207 sets the state of the device 200 to the diagnostic no memory state 112 and disables access to the non-volatile memory 202. The memory state 112 may utilize a switch, a logic circuit, or any other circuitry to gate or decouple the non-volatile memory 202 from being accessed. In some examples, the security manager 207 can use any combination of hardcoded logic and/or programmable logic that executes or instantiates the machine-readable instructions 212b (also referred to as computer readable instructions or instructions) to operate.

The interface 208 of FIG. 2 obtains requests to cause the device 200 to enter a diagnostic mode from a manufacturer. After a device is returned to the manufacturer for debugging, the manufacturer submits a request for the device 200 to enter the diagnostic mode to perform the debugging protocol. To ensure that the manufacturer is authentic and that they are performing the correct protocol on the correct device, the diagnostic mode request may include manufacturer credentials (e.g., a unique identifier, a password, a user name, etc.) and a customer credential (e.g., a customer provider password, a customer provided user name, a unique identifier of the device 200, etc.) via the interface 208. The interface 208 forwards the request and credentials to the security manager 207. If the credentials are not authenticated, the interface 208 may output a signal indicative of an authentication error back to the entity that transmitted the diagnostic mode request.

The processor circuitry 210 of FIG. 2 obtains the credentials from the manufacturer via the interface 208 and the security manager 207. The processor circuitry 210 authenticates the manufacturer credentials. For example, the processor circuitry 210 may compare the manufacturer credentials to stored credentials to verify that the credentials match. Also, the processor circuitry 210 authenticates customer credentials to ensure that the entity requesting diagnostic mode is operating on the intended device. The processor circuitry 210 may compare the customer credentials to stored credentials to verify that the credentials match. If the processor circuitry 210 determines that the credentials are authentic, the processor circuitry 210 outputs a signal to the security manager 207 to proceed with entering into the diagnostic mode and allow access to the device 200. If the processor circuitry 210 determines that the credentials are invalid or not authentic, the processor circuitry 210 outputs a signal to the security manager 207 to prevent entering into the diagnostic mode. In some examples, the processor circuitry 210 can use any combination of hardcoded logic and/or programmable logic that executes or instantiates the machine-readable instructions 212c (also referred to as computer readable instructions or instructions) to operate.

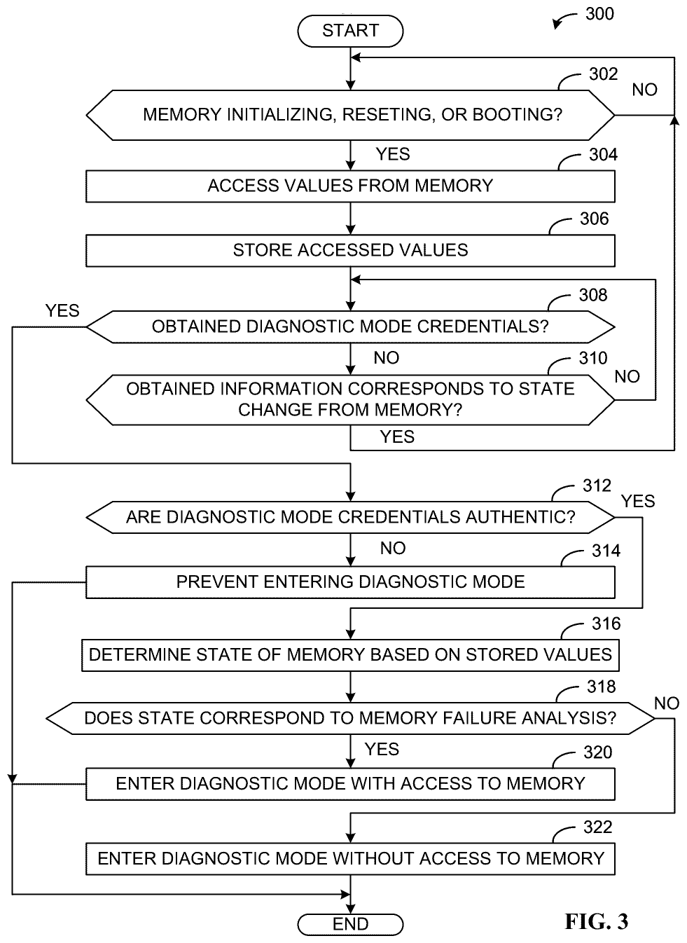

FIG. 3 illustrates a flowchart representative of a method or operations 300 that may be executed or instantiated by the memory controller 205, the DMA controller 206, the security manager 207, the processor circuitry 210, or any other component of the device 200 of FIG. 2 to facilitate failure analysis of the device 200. The machine-readable instructions or the operations 300 of FIG. 3 begin at block 302, at which the DMA controller 206 determines if the non-volatile memory 202 is booting, initializing, or resetting. The non-volatile memory 202 is booted/initialized/reset during power up and/or after the user changes the state of the non-volatile memory 202.

If the DMA controller 206 has not obtained information corresponding to a state change for the non-volatile memory 202 (block 302: NO), control returns to block 302 until state change information has been obtained. If the DMA controller 206 obtains information corresponding to a state change from the non-volatile memory 202 (block 302: YES), the DMA controller 206 accesses the state values from the memory cells 204 of the non-volatile memory 202 (block 304). For example, the DMA controller 206 can perform a DMA to obtain the state values stored in the memory cells 204. At block 306, the example DMA controller 206 stores the accessed state values into any combination of registers, flip flops, or other storage devices of the security manager 207.

At block 308, the example security manager 207 determines if diagnostic mode credentials have been obtained. As described above in conjunction with FIG. 2, after the device 200 is returned to the manufacturer for debugging, the manufacturer connects to the interface 208 of the device to provide a diagnostic mode request with one or more credentials for the diagnostic mode. Thus, after the interface 208 obtains the diagnostic mode request, the interface 208 provides the request and corresponding credentials to the security manager 207. If the security manager 207 determines that diagnostic mode credentials have been obtained via the interface 208 (block 308: YES), control continues to block 312. If the security manager 207 determines that the diagnostic mode credentials have not been obtained (block 308: NO), the DMA controller 206 determines if information corresponding to a state change has been obtained from the non-volatile memory 202 (block 310). If the DMA controller 206 determines that information corresponding to a state change from the non-volatile memory 202 has not been obtained (block 310: NO), control returns to block 308. If the DMA controller 206 determines that information corresponding to a state change from the non-volatile memory 202 has been obtained (block 310: YES), control returns to block 302.

At block 312, the processor circuitry 210 determines if the diagnostic mode credentials are authentic. For example, the processor circuitry 210 compares the one or more credentials to stored credentials to determine whether the obtained credentials match the stored credentials. If the processor circuitry 210 determines that the diagnostic mode credentials are not authentic (block 312: NO), the processor circuitry 210 outputs a signal to the security manager 207 to prevent entering the diagnostic mode (block 314). If the processor circuitry 210 determines that the diagnostic mode credentials are authentic (block 312: YES), the security manager 207 determines the state of the non-volatile memory 202 based on the stored state values that were accessed from the memory cells 204 (block 316). As described above, the stored state values correspond to the state of the non-volatile memory 202 and can be used to determine if access to the non-volatile memory is needed for failure analysis.

At block 318, the security manager 207 determines if the state of the non-volatile memory 202 corresponds to memory failure analysis. For example, if the security manager 207 determines that, based on the stored state values, the state of the non-volatile memory 202 corresponds to memory failure analysis based the state values corresponding to the HS-FS state 104 or the HS-FA state 110 of FIG. 1. If the security manager 207 determines that, based on the stored state values, the state of the non-volatile memory 202 corresponds to the HS-KP state 106, or the HS-SE state 108 of FIG. 1, the security manager 207 determines that the state of the non-volatile memory 202 does not correspond to memory failure analysis. If the security manager 207 determines that the state corresponds to the memory failure analysis (block 318: YES), the security manager 207 enters into the diagnostic mode with access to the non-volatile memory (e.g., the DGN-M state 114 of FIG. 1) (block 320). If the security manager 207 determines that the state does not correspond to the memory failure analysis (block 318: NO), the security manager 207 enters into the diagnostic mode without access to the non-volatile memory (e.g., the DGN-NOM state 112 of FIG. 1) (block 322).

FIG. 4 illustrates an example table 400 of state values that can be stored in the memory cells 204 of the non-volatile memory 202 and the corresponding non-volatile memory state. FIG. 4 includes four memory cells that each hold one value (e.g., a ‘0’ or a ‘1’). The key provisioned (KP) memory cell holds a value that represents that a key has been provisioned. The user or a processing circuit changes the value in the non-volatile memory 202 which results in the DMA controller 206 setting the value of the KP register to ‘1’ after the customer provisions the keys in the non-volatile memory 202. The code provisioned (CP) memory cell holds a value that represents code being provisioned in the non-volatile memory 202. The user or processing circuit changes the value in the non-volatile memory 202 which results in the DMA controller 206 setting the value of the CP register to ‘1’ after the customer provisioned code into the non-volatile memory 202. The FA memory cell holds a value that represents the RMA protocol being executed to enter FA analysis for the non-volatile memory 202. The user or processing circuit changes the value in the non-volatile memory 202 which results in the DMA controller 206 setting the value of the FA register to ‘1’ after the customer executes the RMA protocol.

As shown in the example table 400, if the state values of the KP, CP, and FA memory cell are ‘0,’ the state of the non-volatile memory 202 is associated with the HS-FS state 104 of FIG. 1. If the state values of the CP and FA memory cell are ‘0’ and the value of the KP memory cell is ‘1,’ the state of the non-volatile memory 202 is associated with the HS-FS state 104 of FIG. 1. If the value of the CP memory cell is ‘0’ and the state values of the KP and FA memory cell are ‘1,’ the state of the non-volatile memory 202 is associated with the HS-FA state 110 of FIG. 1. If the value of the FA memory cell is ‘0’ and the state values of the KP and CP memory cell are ‘1,’ the state of the non-volatile memory 202 is associated with the HS-SE state 108 of FIG. 1. If the state values of the KP, CP, and FA memory cell are ‘1,’ the state of the non-volatile memory 202 is associated with the HS-FA state 110 of FIG. 1. In this example, other combinations of state values are unused. In some examples, the customer or device is prohibited from entering state values in the memory cells that correspond to an unused state. For example, a memory controller of the non-volatile memory 220 may prevent state values from being written (e.g., stored) into the memory cells 204 that correspond to an unused state. In some examples, an error message or alert is triggered if state values corresponding to an invalid state are entered. Although the state values in the table 400 reflect particular state values, the state values may be inverted. For example, the ‘0’s in the table may be replaced with ‘1’s and the ‘1’s may be replaced with ‘0’s.

An example manner of implementing the device 200 is illustrated in FIG. 2. However, one or more of the elements, processes and/or devices illustrated in FIG. 2 may be combined, divided, re-arranged, omitted, eliminated and/or implemented in any other way.

Further, the non-volatile memory 202, the memory controller 205, the DMA controller 206, the security manager 207, the interface 208, and/or the processor circuitry 210 may be implemented by hardware, software, firmware and/or any combination of hardware, software and/or firmware. As a result, for example, any of the non-volatile memory 202, the DMA controller 206, the security manager 207, the interface 208, and/or the processor circuitry 210 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the non-volatile memory 202, the memory controller 205, the DMA controller 206, the security manager 207, the interface 208, and/or the processor circuitry 210 is/are hereby expressly defined to include a non-transitory computer readable storage device or storage disk such as a memory, a digital versatile disk (DVD), a compact disk (CD), a Blu-ray disk, etc., including the software and/or firmware. Further still, the non-volatile memory 202, the memory controller 205, the DMA controller 206, the security manager 207, the interface 208, and/or the processor circuitry 210 may include one or more elements, processes and/or devices in addition to, or instead of, those illustrated in FIG. 2, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

A flowchart representative of example hardware logic, machine-readable instructions, hardware implemented state machines, and/or any combination thereof for implementing the device 200 of FIG. 2 are shown in FIG. 3. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowchart illustrated in FIG. 3, many other methods of implementing the device 200 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 3 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having”, and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The terms “couple,” “coupled,” “couples,” and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple,” “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIG. 2, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

The term “or” or “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

Example methods, apparatus, systems, and articles of manufacture to facilitate access control in memory are described herein. Further examples and combinations thereof include the following: Example 1 includes an apparatus comprising a non-volatile memory configured to store a set of state values, processor circuitry coupled to the non-volatile memory and configured to store data to the non-volatile memory, and security manager circuitry coupled to the non-volatile memory and configured to access the set of state values, responsive to obtaining a request to enter a diagnostic mode, authenticate credentials corresponding to the request, determine a state of the non-volatile memory based on the set of state values, and determine whether to permit or prohibit access to the non-volatile memory based on the determined state.

Example 2 includes the apparatus of example 1, wherein the credentials include manufacturer credentials and device credentials.

Example 3 includes the apparatus of example 1, wherein the processor circuitry is configured to cause the set of state values to be stored based on the storing of the data to the non-volatile memory.

Example 4 includes the apparatus of example 1, wherein the security manager circuitry is configured to permit access to the non-volatile memory based on determining that the state corresponds to a non-volatile memory failure.

Example 5 includes the apparatus of example 1, wherein the state of the non-volatile memory corresponds to a key provisioned state, a code provisioned state, or a non-volatile memory failure state.

Example 6 includes the apparatus of example 5, wherein the security manager circuitry is configured to prohibit access to the non-volatile memory based on determining that the state corresponds to the key provisioned state or the code provisioned state.

Example 7 includes the apparatus of example 1, wherein the security manager circuitry is configured to transition to the diagnostic mode based on the authentication of the credentials.

Example 8 includes a method comprising accessing state values stored in non-volatile memory, the state values corresponding to a state of the non-volatile memory, responsive to obtaining a request to enter a diagnostic mode, authenticating credentials corresponding to the request, determining the state of the non-volatile memory based on the state values, and determining whether to permit or prohibit access to the non-volatile memory based on the determined state.

Example 9 includes the method of example 8, wherein the credentials include manufacturer credentials and device credentials.

Example 10 includes the method of example 8, wherein a user defines the state.

Example 11 includes the method of example 8, wherein the permitting of the access to the non-volatile memory is based on determining that the state corresponds to a non-volatile memory failure.

Example 12 includes the method of example 8, wherein the state of the non-volatile memory corresponds to a key provisioned state, a code provisioned state, or a non-volatile memory failure state.

Example 13 includes the method of example 12, wherein the prohibiting of the access to the non-volatile memory is based on determining that the state corresponds to the key provisioned state of the code provisioned state.

Example 14 includes the method of example 8, further including entering the state to the diagnostic mode based on the authentication of the credentials.

Example 15 includes a device comprising a non-volatile memory that includes a memory bank configured to store a set of state values corresponding to a state of the non-volatile memory, and a memory controller coupled to the non-volatile memory and configured to write the set of state values to the memory bank based on the state of the non-volatile memory.

Example 16 includes the non-volatile memory of example 15, wherein the memory bank includes three memory cells that store data corresponding to the state of the non-volatile memory.

Example 17 includes the non-volatile memory of example 15, wherein the state of the non-volatile memory corresponds to a key provisioned state, a code provisioned state, or a non-volatile memory failure state.

Example 18 includes the non-volatile memory of example 15, further including a direct memory access controller to cause the set of state values to be stored in a register of security manager circuitry.

Example 19 includes the non-volatile memory of example 15, wherein the memory controller is to prevent the set of state values from being written to the memory bank when the set of state values correspond to an unused state.

Example 20 includes the non-volatile memory of example 15, wherein the memory controller is to, responsive to a direct memory access instruction, output the set of state values.

Modifications are possible in the described examples, and other examples are possible, within the scope of the claims.

What is claimed is:

1. An apparatus comprising:
a non-volatile memory configured to store a set of state values;
processor circuitry coupled to the non-volatile memory and configured to store data to the non-volatile memory; and
security manager circuitry coupled to the non-volatile memory and configured to:
access the set of state values;
responsive to obtaining a request to enter a diagnostic mode, authenticate credentials corresponding to the request;
determine a state of the non-volatile memory based on the set of state values; and
determine whether to permit or prohibit access to the non-volatile memory based on the determined state.

2. The apparatus of claim 1, wherein the credentials include manufacturer credentials and device credentials.

3. The apparatus of claim 1, wherein the processor circuitry is configured to cause the set of state values to be stored based on the storing of the data to the non-volatile memory.

4. The apparatus of claim 1, wherein the security manager circuitry is configured to permit access to the non-volatile memory based on determining that the state corresponds to a non-volatile memory failure.

5. The apparatus of claim 1, wherein the state of the non-volatile memory corresponds to a key provisioned state, a code provisioned state, or a non-volatile memory failure state.

6. The apparatus of claim 5, wherein the security manager circuitry is configured to prohibit access to the non-volatile memory based on determining that the state corresponds to the key provisioned state or the code provisioned state.

7. The apparatus of claim 1, wherein the security manager circuitry is configured to transition to the diagnostic mode based on the authentication of the credentials.

8. A method comprising:
accessing state values stored in non-volatile memory, the state values corresponding to a state of the non-volatile memory;
responsive to obtaining a request to enter a diagnostic mode, authenticating credentials corresponding to the request;
determining the state of the non-volatile memory based on the state values; and
determining whether to permit or prohibit access to the non-volatile memory based on the determined state.

9. The method of claim 8, wherein the credentials include manufacturer credentials and device credentials.

10. The method of claim 8, wherein a user defines the state.

11. The method of claim 8, wherein the permitting of the access to the non-volatile memory is based on determining that the state corresponds to a non-volatile memory failure.

12. The method of claim 8, wherein the state of the non-volatile memory corresponds to a key provisioned state, a code provisioned state, or a non-volatile memory failure state.

13. The method of claim 12, wherein the prohibiting of the access to the non-volatile memory is based on determining that the state corresponds to the key provisioned state of the code provisioned state.

14. The method of claim 8, further including entering the state to the diagnostic mode based on the authentication of the credentials.

15. A device comprising:
a non-volatile memory that includes a memory bank configured to store a set of state values corresponding to a state of the non-volatile memory; and
a memory controller coupled to the non-volatile memory and configured to write the set of state values to the memory bank based on the state of the non-volatile memory.

16. The non-volatile memory of claim 15, wherein the memory bank includes three memory cells that store data corresponding to the state of the non-volatile memory.

17. The non-volatile memory of claim 15, wherein the state of the non-volatile memory corresponds to a key provisioned state, a code provisioned state, or a non-volatile memory failure state.

18. The non-volatile memory of claim 15, further including a direct memory access controller to cause the set of state values to be stored in a register of security manager circuitry.

19. The non-volatile memory of claim 15, wherein the memory controller is to prevent the set of state values from being written to the memory bank when the set of state values correspond to an unused state.

20. The non-volatile memory of claim 15, wherein the memory controller is to, responsive to a direct memory access instruction, output the set of state values.
